(19) United States
(12) Patent Application Publication
(10) Pub. No.: US 2014/0110311 A1
(43) Pub. Date: Apr. 24, 2014

(54) METHOD AND APPARATUS FOR FROTH FLOTATION CONTROL

(71) Applicants: Johannes Jacobus Le Roux Cilliers, London (GB); Kathryn Hadler, London (GB)

(72) Inventors: Johannes Jacobus Le Roux Cilliers, London (GB); Kathryn Hadler, London (GB)

(73) Assignee: IMPERIAL INNOVATIONS LIMITED, London, Greater London (GB)

(21) Appl. No.: 14/119,409

(22) PCT Filed: May 15, 2012
(86) PCT No.: PCT/GB2012/051078

§ 371 Date: Nov. 21, 2013

(30) Foreign Application Priority Data
May 23, 2011 (GB) 1108672.5

(51) Int. Cl. B03D 1/02

(52) U.S. Cl. CPC B03D 1/028
USPC 209/165; 209/168

(57) ABSTRACT

A method of controlling operation of a froth flotation cell comprises introducing gas into a liquid in the cell, thereby to create a froth on the surface of the liquid, which froth overflows and leaves the cell at an overflow point, wherein the froth has a froth height from the level of the overflow point to the upper surface of the froth, measuring values of the froth height for two values of gas flow rate into the cell, measuring values the velocity at which the froth overflows at the overflow point for two values of gas flow rate into the cell, calculating a gas flow rate into the cell that optimises gas recovery, by treating the measured values of froth height and measured values of froth velocity independently, and setting the gas flow rate into the cell to be the calculated flow rate into the cell that optimises gas recovery.

This invention relates to a method and apparatus of controlling one or more froth flotation cells for separating substances.

Froth flotation is a method of performing a separation that is used in various different industries. For example, froth flotation is used to separate different minerals in an ore, or for de-inking paper or for cleaning coal.

The present invention, and the background thereto, is discussed primarily with reference to the separation of minerals in an ore, but the invention is not limited to this particular use of froth flotation. The invention is applicable to all froth flotation processes.

Mineral froth flotation is a known industrial process used for extracting valuable mineral content from ore obtained for example through mining. It is a surface chemistry process used to separate solids, typically fine solids, by exploiting the variation in hydrophilicity between different materials.

A flotation cell or vessel contains a pulp of matter such as ore from which the mineral is to be extracted mixed with liquid. Gas is flowed through the pulp and separation is achieved by the selective adherence of hydrophobic particles to gas bubbles whilst any hydrophilic particles remain in the liquid which flows between the gas bubbles in the vessel. When bubbles rise to the top of the vessel a froth is formed.

The froth extends from the pulp-froth interface to a bursting surface, which is typically above the overflow lip. A “froth depth” is defined as the distance between the pulp-froth interface and the overflow lip. A “froth height” is defined as the distance from the overflow lip to the bursting surface.

The froth can be arranged to overflow from the flotation vessel with both hydrophobic and hydrophilic particles comprised therein. Those particles can be extracted as a concentrate. Typically, in mineral froth flotation, it is the hydrophobic particles that are the desired product, and are intended to be recovered from the froth.

The remaining pulp in the flotation vessel is commonly referred to as the tailings. In some froth flotation processes (such as the de-inking of paper) it is the remaining pulp in the flotation vessel that is the desired product.

In practice a froth flotation plant will contain multiple cells, typically arranged in banks of similar type, where material is fed through the bank, cell by cell, and then on to the next bank. Cell types may differ between banks, the initial bank, for example, containing “roughers” which are used for initial crude separation of desired matter from undesired matter. Downstream, banks may include secondary roughers, also known as “scavengers”, which perform additional separation on the pulp that remains in a rougher after froth has been overflown therefrom. Downstream banks may also include “cleaners”, which perform separation on froth that has been extracted from roughers or scavengers.

The performance quality of a flotation process can be measured with respect to two characteristics of the concentrate that is extracted from the flotation vessel—“grade” and “recovery”. When referring to mineral systems in which the desired product is recovered from the froth, grade indicates the fraction of desired solids in the concentrate as compared to undesired solids (gangue). Recovery indicates the fraction of desired solids in the concentrate as compared to the fraction of desired solids in the original ore feed that was input into the flotation cell. An industrial flotation process is manipulated in order to achieve an optimal balance between grade and recovery, with an ideal flotation process producing high recovery of high-grade concentrate.

It is known that several controllable factors can affect the performance quality of a flotation process. These include the pH of the pulp, the concentration of various chemicals added to the flotation vessel, solids concentration and gas flow rate into the flotation vessel. However, the presence of so many variables makes quantitative control of froth flotation processes difficult.

According to known methods of controlling and operating a froth flotation plant, a controller can observe a flotation cell and manually or otherwise adjust the inputs to the cell, for example by adding additional chemicals and/or changing the gas flow rate into the cell, according to his or her observations. Typically these adjustments are empirical, based particularly on observation of the froth surface and its behaviour. However, such methods of adjustment are often imprecise.

Furthermore, changes in certain visual aspects of a flotation froth do not correspond necessarily to variation in output performance quality.

In addition, modern industrial processes make use of increasingly large flotation cells. This increase in size tends to encourage the use of increased power and gas volume in flotation cells, regardless of performance considerations, increasing the inefficiency inherent in existing control and operation methods. Problems therefore remain in known practical flotation methods with respect to which variables should be observed, measured and controlled in order to optimise flotation performance, as well as how to manipulate those relevant variables accurately.

A discussion of investigating froth flotation performance is provided in Barbian et al, “The Froth Stability Column—Measuring Froth Stability at an Industrial Scale”, Minerals Engineering, Vol 19, No. 6-8, 713-718 in which correlations are identified between a froth stability factor, gas rate and froth depth in a single cell.

WO 2009/044149 discloses a method of froth flotation control in which the flow rate of gas into the cell is varied in order to optimise the fraction of the input gas which is recovered in the froth overflowing the cell (as opposed to gas input into the cell which forms bubbles that subsequently burst and therefore escapes from the cell). Hence, WO 2009/044149 discloses how one variable (the gas flow rate) may be optimised for a froth flotation system. However, the method of WO 2009/044149 is time consuming and experimentally intensive, because it requires taking many measurements to identify the optimum gas flow rate.

According to a first aspect of the invention, there is provided a method of controlling operation of a froth flotation cell, the method comprising: introducing gas into a liquid in the cell, thereby to create a froth on the surface of the liquid, which froth overflows and leaves the cell at an overflow point, wherein the froth has a froth height from the level of the overflow point to the upper surface of the froth, measuring values of the froth height for two values of gas flow rate into the cell, measuring values of the velocity at which the froth overflows at the overflow point for two values of gas flow rate into the cell, calculating a gas flow rate into the cell that optimises gas recovery, by treating the measured values of froth height and measured values of froth velocity independently, and setting the gas flow rate into the cell to be the calculated flow rate into the cell that optimises gas recovery.

This method enables the optimum value of input gas flow rate to be determined by calculation without performing extensive experimental trials. Being able mathematically to derive the gas flow rate that optimises the gas recovery in the froth means that the optimum conditions for the cell can more readily be determined, allowing more efficient operation of the froth flotation cell. The method also allows for the simplification of existing control strategies, because it is no longer necessary actively to seek the optimum gas input flow rate. Rather, the optimum gas flow rate can be set, in the knowledge that the cell will then be operating at the most efficient point.

Further, the treatment of the measured values of the froth height and froth velocity independently of each other provides a further simplification to determining the optimum gas flow rate. Past methods of determining the gas flow rate giving peak gas recovery required the calculation of the air recovery, which in turn required measurements such as froth height and froth velocity to be taken at each point (i.e. gas flow rate) of interest and for measurements to be taken either side of the optimal gas flow rate. According to the present method measurements of froth height and froth velocity may be taken for different values of input gas flow rate and the subsequent data can be analysed independently. The calculations can be performed without measurements necessarily being made at gas flow rates either side of the optimal flow rate.

The step of using the measured values to calculate a gas flow rate into the cell that optimises gas recovery can further comprise determining a correlation between the measured values of froth velocity and the gas flow rate into the cell, and determining a correlation between the measured values of froth height and the gas flow rate into the cell.

Advantageously, the present invention has identified that considering the relationship to the gas flow rate of the froth height and froth velocity individually, rather than considering the overall relationship between gas recovery and gas input flow rate, simple correlations can be identified. By using these correlations, it is possible mathematically to predict the gas flow rate setting that will optimise the gas recovery for the cells.

The correlations can be linear correlations of the form y=mx+c, wherein y is the measured value of the froth velocity or froth height, x is the gas flow rate into the cell and m and c are derived coefficients.

The method can further include calculating the gas flow rate into the cell that optimises gas recovery using the coefficients m and c of the linear correlations.

The gas flow rate into the cell that optimises gas recovery can be calculated using the following equation:

$${Q}_{a} = {( \frac{{c}_{v} {c}_{h}}{{m}_{v} {m}_{h}} )}^{1 / 2}$$

wherein Qₐ is the gas flow rate into the cell that optimises gas recovery, mᵥ and cᵥ are the coefficients of the liner correlation between the gas flow rate into the cell and the froth velocity, and mₕ and cₕ are the coefficients of the liner correlation between the gas flow rate into the cell and the froth height.

Establishing linear correlations between the froth height and the gas flow rate, and froth velocity and gas flow rate mean that the optimal gas flow rate can be calculated using only the coefficients of the linear correlations. As such, once the correlations have been determined it is easy to set the gas flow rate into the cell at the correct value to optimise the gas recovery.

In the method of the invention, the gas flow rate can be a nominal or apparent gas flow rate. The step of setting the gas flow rate into the cell can comprise setting the gas flow rate relative to the values of the gas flow rate using the steps of measuring.

One of the advantages of the present invention is that it is not necessary to know the actual value of the gas flow rate into the cells. According to prior experimental methods, it was necessary to determine the actual gas flow rate into the cell (even if this was not accurately represented on the gas inlet valve, for example) in order to calculate the air recovery which is defined as the ratio of the air overflowing in the froth to the air supplied to the cells. However, in the present method it is only necessary to know nominal or apparent gas flow rates (i.e. as may be represented by inlet valve settings or flow meter readings) without knowing the actual values of the gas inlet flow rates used. That is, it is not necessary to know the actual flow rates either when taking the measurements for the calculations or when finally setting the gas flow rates to the desired value. All the steps may be taken using only apparent gas flow rates.

The method can comprise using a detector to measure the velocity at which froth overflows from the cells. The detector can optionally comprise a camera image analysis system. Measuring the froth height can optionally comprise using a laser measure to measure the froth height.

Preferably the liquid contains both desired matter to be recovered and undesired matter to be discarded, and the cell is operable to perform at least partial separation of the desired matter and undesired matter. Typically, one of either the undesired or desired matter is made hydrophobic, whilst the other is made hydrophilic, and separation is achieved by the preferential recovery of the hydrophilic material in the liquid and the hydrophobic material in the froth.

The liquid may include froth overflow from a froth flotation cell. That is, the cell being controlled may be a downstream cell that receives input liquid from froth overflowing from an upstream cell. Such arrangements are used for further refining the froth obtained from the upstream cell.

In a preferred embodiment, the liquid contains particles of an ore, and the ore contains minerals to be separated from the remainder of the ore. This allows valuable, metal carrying, minerals to be separated from other waste minerals (gangue).

The invention also provides a method of controlling operation of a bank of froth flotation cells including individually controlling cells according to any of the methods mentioned above.

Further, there is provided a method of controlling operation of a plant comprising a plurality of froth flotation cell banks including individually controlling banks according to any one of the previously mentioned methods.

The invention also provides a method of operating a froth flotation cell including controlling operation of the cell according to any of the previously mentioned methods of controlling operation of a froth flotation cell.

Further, there is provided a method of operating a bank or plant comprising a plurality of froth flotation cells including controlling operation of the cells individually according to the aforementioned method of claim.

The invention also provides a method of obtaining a substance from a liquid containing two or more substances including adding said liquid to a froth flotation cell, operating the cell according to the method of either of the previous two methods, and obtaining the substance from the froth which overflows the cell during operation.

According to another aspect of the invention, there is provided a substance recovered from froth which overflows from a froth flotation cell, or liquid retained in the cell, wherein said froth flotation cell is controlled according to any previously mentioned method of controlling operation of a froth flotation cell.

There is also provided a computer readable medium for controlling a froth flotation cell according to the method of any one of the previously mentioned methods of controlling operation of a froth flotation cell.

According to another aspect of the invention there is provided a froth flotation cell comprising: a gas inlet for introducing gas into a liquid in the cell and, a controller configured to calculate a gas flow rate into the cell that optimises gas recovery based upon measured values of froth height for two values of gas flow rate into the cell and measured values of froth velocity for two values of gas flow rate into the cell, the calculation being performed by treating the measured values of froth height and the measured values of froth velocity independently, the controller being further configured and to control the gas inlet to set the gas flow rate into the cell to be the calculated flow rate into the cell that optimises gas recovery.

According to another aspect of the invention there is provided a control system for controlling a flotation cell, the control system comprising a measuring unit for measuring values of froth height and froth velocity, a calculating unit for calculating a gas flow rate into the cell that optimises gas recovery based upon values measured by the measuring unit, the calculation being performed by treating the measured values of froth height and the measured values of froth velocity independently, and a controller to set the gas flow rate into the cell to be the calculated flow rate into the cell that optimises gas recovery.

In another embodiment there is provided froth flotation plant including a plurality of froth flotation cells as described above.

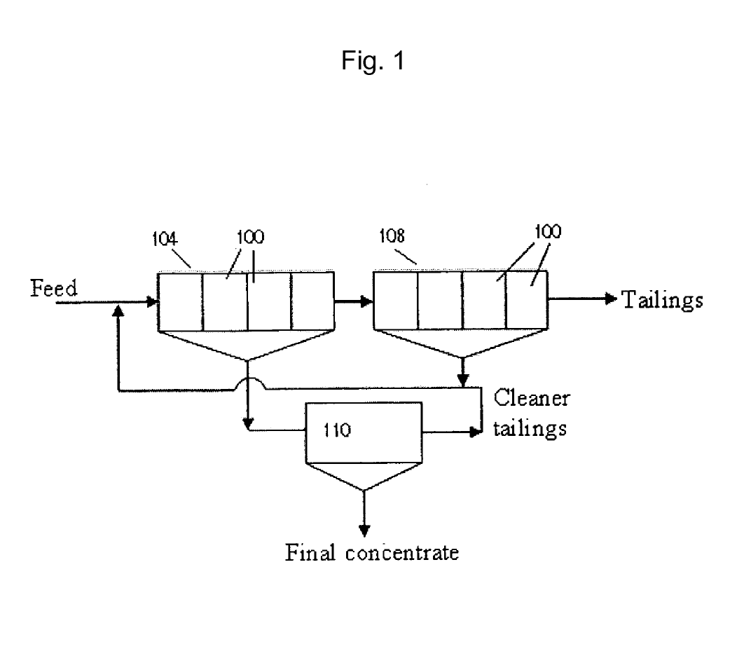

FIG. 1 shows a schematic view of an embodiment of a flotation circuit;

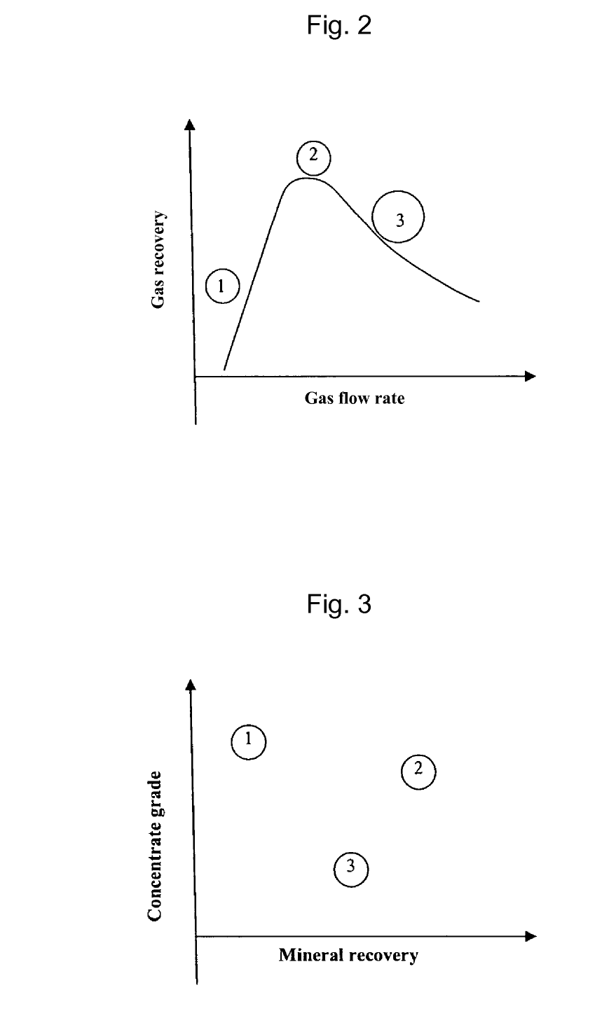

FIG. 2 shows a plot of gas recovery versus gas flow rate for a froth flotation cell;

FIG. 3 shows a plot of concentrate grade versus mineral recovery at three different gas flow rates for a froth flotation cell;

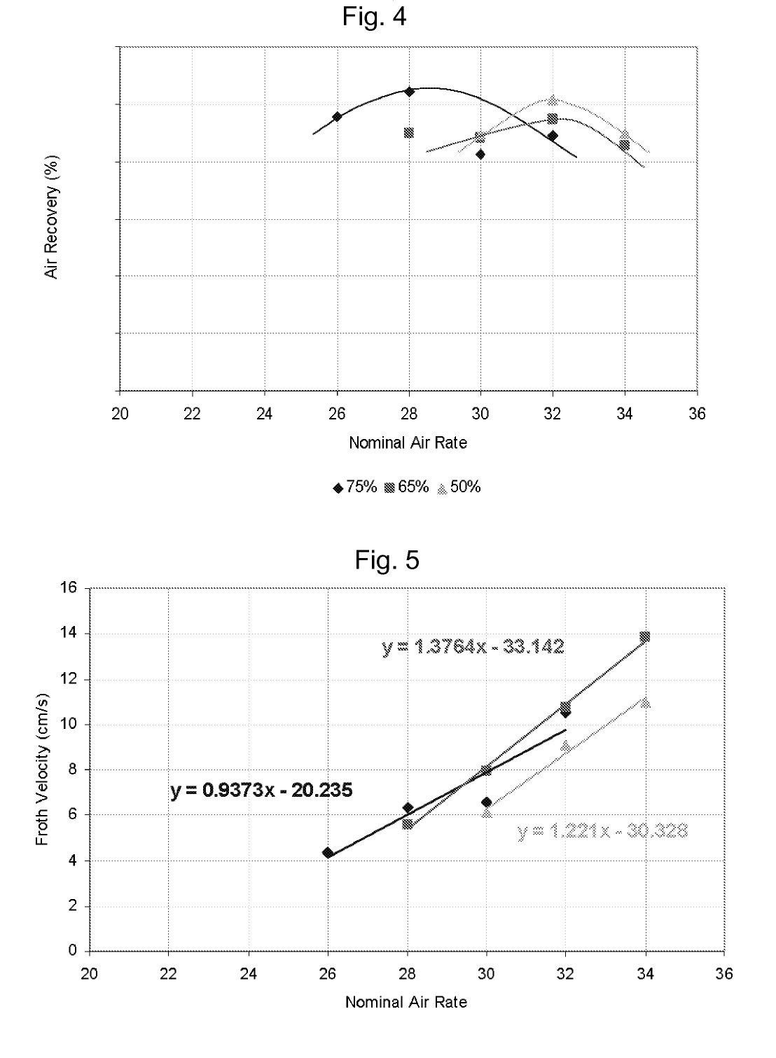

FIG. 4 is an example plot of industrial data showing the relationship between air recovery and nominal air rate for three different froth depths;

FIG. 5 is a graph showing the relationship between nominal air rate and froth velocity for the three different froth depths of FIG. 4;

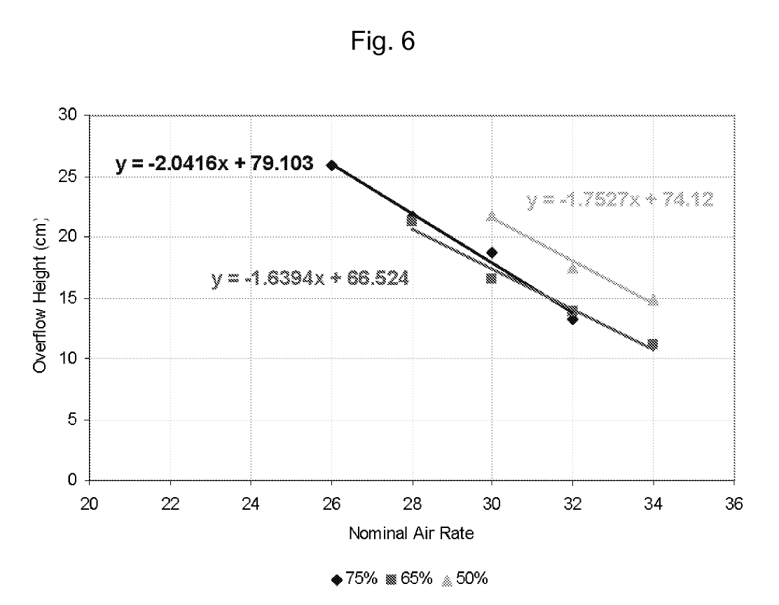

FIG. 6 is a graph showing the relationship between nominal air rate and froth height for the three different froth depths of FIG. 4

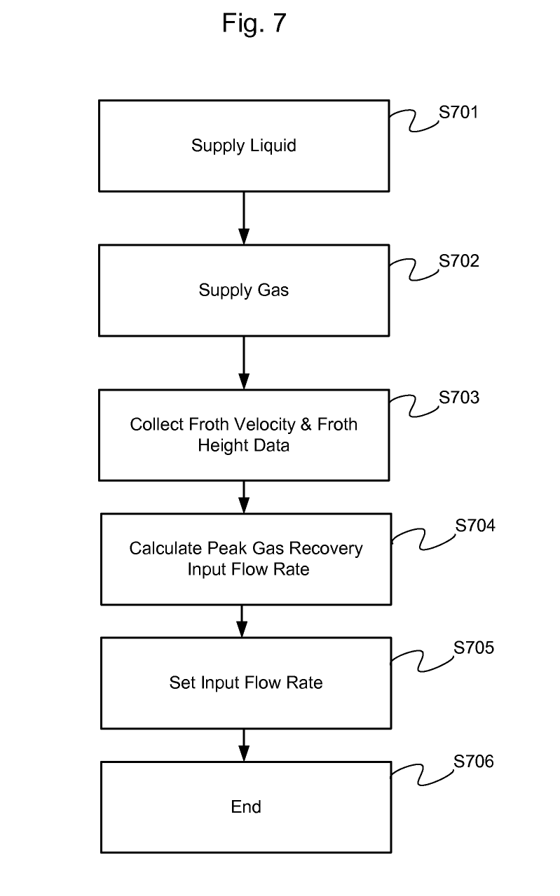

FIG. 7 is a flow chart indicating a method according to the present invention.

The present invention derives from the realisation that it is unnecessary to know the precise value of the gas flow rate into a froth flotation cell in order to optimise the gas flow rate to achieve the peak gas recovery. Gas recovery is defined as the ratio of the amount of gas recovered in froth overflowing a cell to the amount of gas supplied to the cell. This is advantageous because measuring input gas flow rates precisely can be difficult. The present invention has identified that as long as the true gas flow rate and the apparent gas flow rate vary proportionally, the apparent gas flow rate achieving peak gas recovery can be calculated.

In contrast, in the past, methods of determining the gas flow rate providing peak gas recovery have been experimentally intensive, reliant on taking many measurements.

In overview, the present invention provides a method for controlling operation of one or more froth flotation cells. In operation, air or other suitable flotation gas (including gas mixtures), such as nitrogen, is introduced into a froth flotation cell containing a liquid in order to create a froth. The liquid contains, for example, solid particles of an ore (including minerals containing valuable metal to be recovered). Overflow of the froth from the cell is then observed for different input gas flow rates, and the overflow froth velocity and froth height are measured. From these measurements, the optimum input gas flow rate can be determined, even if the input gas flow rate is only known in terms of nominal values (i.e. even if the precise flow rate is not known and it is only known that one flow rate is a certain multiple or factor of another flow rate for example). Having calculated the optimal gas flow rate, the input of gas into the froth flotation cell can be controlled to be the optimum value.

Referring to FIG. 1, the apparatus is shown generally as a circuit having a number of banks or sub-banks, each including a plurality of froth flotation cells 100. It will be appreciated that the particular layout of the flotation circuit, the numbers of cells 100 that comprise each bank or sub-bank and the flow configuration of the various streams can vary widely. Each bank or sub-bank of cells may include any number or arrangement of cells 100, dependent on the practical conditions to be achieved. The cells 100 are connected to one another by any known means so that at least some of the contents of one cell 100 can be channelled into another cell 100. The practice of froth flotation and the design of such operations is known to the skilled person and is described in detail in, for example, Wills' Mineral Processing Technology, 7th edition (Wills, B. A. and Napier-Munn, T.).

A liquid containing two or more substances can be added to a froth flotation cell or cells 100 for separation, either wherein a desired substance is extracted from the froth which overflows the cell or wherein the froth includes undesired substances, so that a desired substance can be extracted from the pulp which remains in the cell after operation. In the context of the minerals industry, the substances are metal-containing minerals in an ore containing the minerals and gangue.

In the embodiment shown in FIG. 1 the flotation circuit includes a bank of rougher cells 104 into which a liquid feed typically water containing particles of ore, is introduced. Downstream from the rougher bank 104 there is provided a secondary rougher or “scavenger” bank 108 and a cleaner bank 110. Optionally, the circuit may include more than one rougher 104, scavenger 108 or cleaner 110 bank or sub-bank. In addition, both cleaners 110 and re-cleaners may be included. According to the embodiment as shown, both the cleaner 110 and the scavenger 108 include feedback channels for re-introducing material into the rougher 104 for additional processing.

In operation, ore from which a desired metal-containing mineral is to be separated and then extracted is crushed using any appropriate means. The crushed matter is then fed into a mill to be further broken down into a fine particle size, for example powder. The required particle size in any given situation will be dependent on a range of factors, including mineralogy, etc and can readily be determined. After milling, the particles are chemically treated in order to induce the appropriate wettability characteristics of the desired mineral that is to be separated and then extracted using the flotation process. According to a preferred embodiment, the particles are treated so that the surface of desired mineral is both hydrophobic and aerophilic. This ensures that the mineral will be strongly attracted to a gas interface such as a gas bubble and that air or other flotation gas will readily displace water at the surface of the desired mineral.

All undesired matter is preferably chemically treated so as to be hydrophilic. The methods for chemical treatment of the particles are well known and so are not discussed further herein.

In order to carry out a froth flotation process and separate and extract the desired mineral, the chemically treated particles are introduced into a cell 100 with water or other liquid. Bubbles of air or other gas are then introduced into the liquid (also referred to as a “slurry”, due to the presence of the solid particles) at a controlled rate via one or more gas inlets (not shown). Typically, the gas is supplied to the gas inlet or inlets of the cell 100 via a blower or other suitable apparatus. During this operation of the cell 100, the slurry at least partially separates so that at least some of the hydrophobic particles of desired mineral adhere to the gas bubbles whilst hydrophilic particles of undesired material and, dependent on conditions in the cell, some of the hydrophobic particles, will remain in the liquid.

The difference in density between the gas bubbles and the liquid dictates that the bubbles rise to the upper surface of the slurry in the cell 100, to create a froth thereon. The froth contains both bubbles and liquid that flows in the channels formed between the bubbles. The froth therefore contains both desired particles and undesired particles. In order for the desired particles to be extracted, conditions in the cell 100 are controlled so that at least some of the froth overflows from the cell 100. The froth that overflows or is removed from the cell 100 is either introduced into a further flotation cell 100 and/or forms a concentrate that includes the desired mineral to be recovered therefrom. Methods of concentrate recovery from froth and methods of extraction of valuable materials from such a concentrate will be well known such that further discussion of these is not provided.

In the embodiment shown in FIG. 1, once feed has been introduced into the rougher 104, the rougher 104 performs a froth flotation process as described above. The froth produced by the rougher 104 during that process is channelled into the cleaner 110 whilst the tailings from the rougher 104 are introduced into the scavenger 108. Both the scavenger 108 and the cleaner 110 then perform a froth flotation process as described. The froth produced by the scavenger 108 and the tailings produced by the cleaner are reintroduced into the rougher 104 for further processing. The tailings from the scavenger 108 are then discarded whilst the froth output from the cleaner 100 is harvested for extraction of the final concentrate as described above.

A range of variables and operational boundary conditions in the froth flotation cells 100 can be monitored and controlled in an attempt to achieve good recovery and good grade of the extracted concentrate.

As mentioned above, varying the gas flow rate to optimise gas recovery in the froth results in a froth having both a high concentrate grade and also high mineral recovery. The skilled person will appreciate that flotation froths are stabilised by the hydrophobic particles. The amount of particles which become loaded onto the bubbles is an important factor in the stability of the froth and will depend on the input gas flow rate. The peak in gas recovery is therefore due to the balance of loading on the bubbles to stabilise them (which generally decreases with increasing gas rate), and the flow velocity to the overflow lip of the flotation cell (which generally increases with increasing gas rate, until the gas recovery is too low because the bubbles burst too quickly).

Referring to the numbered points on FIG. 2, the relationship between gas recovery and gas flow rate is explained as follows:
1. At low gas flow rates the bubbles are heavily loaded as the ratio of hydrophobic particles to bubble surface area is relatively low. This prevents coalescence and bursting. Because the gas flow rate is low, in the froth the bubbles also travel slowly and therefore coalesce and burst due to the long time before they reach the overflow lip of the cell, resulting in a low gas recovery. Low gas flow rates may result in such heavy particle loads that the froth collapses under its own weight, also decreasing the gas recovery.
2. As gas flow rate to the cell is increased, particle loading on bubbles decreases, but remains high enough to stabilise the bubbles. The froth is now also flowing faster and bubbles reach the lip before they burst, resulting in an increased fraction of gas overflowing the weir (high gas recovery).
3. If gas flow rate is increased further, the particle-bubble ratio becomes very low, the particle load on the bubbles is low, reducing their stability and the bubbles rapidly burst (low gas recovery).

The relationship between gas recovery and gas rate can now be understood. As described above, flotation performance is a balance between concentrate recovery and concentrate grade. Each of these characteristic measurements is high when the performance of a flotation cell is at its peak. In operation of a flotation cell, the majority of desired solid particles enter the froth attached to bubbles. However, most detach and become entrained in the liquid flowing in channels between bubbles before reaching the lip of the cell. The undesired solids come into the froth by entrainment in the liquid flowing in channels between bubbles. The recovery of both entrained solids and those still attached to bubbles is therefore increased by more bubbles overflowing the lip, which is increased both by high gas rates and by high gas recovery.

As a result, the optimisation of performance of a flotation cell can be achieved due to an increase in extraction of desired solids as the gas recovery increases, balanced with a limited increase of entrained undesired solids because the gas flow rate is not significantly increased in the relevant operating range.

Referring to the numbered points in FIG. 3, which correspond to the gas flow rate and gas recovery points on FIG. 2, this relationship between optimal performance and gas recovery can be understood in more detail as follows:
1. At low gas flow rates there is a low desired mineral recovery due to the low gas recovery. A high grade is obtained due to low undesired solids entrainment as a result of low gas rates and low gas recovery.
2. As the gas flow rate to the cell is increased towards the peak in gas recovery, the mineral recovery increases as the flow of bubbles over the lip increases with an attendant high gas recovery. The concentrate grade decreases somewhat due to an increase in entrainment caused by higher gas rate and high gas recovery. This decrease is relatively small, since the gas flow rate is still low enough to limit the entrainment of undesired solids.
3. If gas flow rate is increased further past the peak in gas recovery, desired solids recovery slows as a result of the lower gas recovery. The concentrate grade also decreases, now significantly, because of the high gas rate causing a high degree of entrainment of undesired solids. Experimental tests have been employed by the applicant to investigate this theory and to show that switching from using known methods of controlling operation of froth flotation cells to using the present method increases both the grade and recovery of the concentrate retrieved, both on an individual cell basis and on a cumulative bank basis.

Gas recovery can be calculated from any one or more of the following measurements: the height of the froth overflowing a flotation cell, obtained for example by measuring the height of the tide mark on a scaled vertical surface perpendicular to the overflow lip; the velocity of the froth overflowing the cell, obtained via image analysis of a flotation cell in operation; the length or perimeter of the cell from which the froth overflows, known to the user from plant measurements; and the gas flow rate into the cell, which is controlled by the user.

Froth velocity can be measured using image analysis systems, with several commercial systems already installed at plants. Overflowing froth height can be measured manually, using a ruler or handheld laser measure, or online by laser.

Measuring the cell inlet gas rate, however, presents a greater challenge. On many plants, calibration of the meters used to measure cell gas rate is poor. There are several different measures available, such as the Anglo Platinum Bubble Sizer, developed by Stone Three of Somerset West, South Africa. However none are continuous, simple and sufficiently cost effective for use on every cell in a circuit. This is a problem for the application of the “peak gas recovery” concept for future control systems. In order to obtain the correct position of peak gas recovery, an accurate measure of cell gas rate is required. That is, it was thought that an incorrect gas rate reading may result in the peak gas recovery flow rate being erroneous.

The present invention identifies and implements a solution to the above-mentioned problem, and is illustrated with reference to FIGS. 4-6.

Gas recovery is used to indicate froth stability, however the non-linearity of gas recovery with gas rate makes it complicated to predict and model. FIG. 4 shows typical plant data, taken from a South African platinum concentrator, showing the response of the measured air recovery with changes in air rate for three different froth depths. For this data, the air rate used in the air recovery calculation was measured using the Anglo Platinum Bubble Sizer, however for clarity, the nominal air rate (that is, the air rate given by the instrumentation) is shown. The curves are approximate, however it can be seen that errors are present in the experimental data, which further complicate the analysis of the data.

However, gas (in this case, air) recovery can be determined using the relationship shown in Equation 1, where the volume of froth overflowing is determined using the velocity of the overflowing froth (v_{f}), the height of the froth overflowing the cell lip (h_{f}) and the cell lip length (L):

$$\begin{matrix}Air Recovery = \frac{Volume air overflowing}{Inlet air rate} \\ = V / {Q}_{a} \\ = \frac{{v}_{f} {h}_{f} L}{{Q}_{a}}\end{matrix} \qquad Equation 1$$

The invention identifies that if the gas recovery is separated into its constituent parts (that is, froth velocity and overflow height), trends start to become apparent.

FIG. 5 and FIG. 6 show the effect of increasing the gas rate on froth velocity and overflowing froth height respectively. These figures show clear linear trends between both responses and the nominal air rate for this froth. That is, the cell is operating in a linear regime. Such behaviour would be expected until, as the cell air rate increases higher, the froth velocity eventually plateaus.

Using the data shown in this range of air rates, it is clear that a linear model can be fitted, of the standard form y=mx+c.

Using mᵥ and mₕ to describe the gradient of the line for froth velocity and height respectively and cᵥ and cₕ to describe the intercept of the line for velocity and height respectively, Equation 1 can be rewritten as:

$$Air Recovery , α = \frac{( {m}_{v} {Q}_{a} + {c}_{v} ) ( {m}_{h} {Q}_{a} + {c}_{h} ) L}{{Q}_{a }} \qquad Equation 2$$

When the gas recovery is at its peak, the rate of change of the gas recovery with respect to the flow rate will be zero. That is:

$$\frac{d α}{d {Q}_{a}} = 0 \qquad Equation 3$$

Rearranging Equation 2 gives:

$$α = \frac{V}{{Q}_{a}} = \frac{( {m}_{v} {m}_{h} {Q}_{a}^{2} + {m}_{v} {Q}_{a} {c}_{h} + {m}_{h} {Q}_{a} {c}_{v} + {c}_{v} {c}_{h} ) L}{{Q}_{a}} \qquad Equation 4$$

Equation 4 may be differentiated with respect to Qₐ using the quotient rule (Equation 5):

$$\frac{d ( V / {Q}_{a} )}{d {Q}_{a }} = \frac{( {Q}_{a} ( \frac{d V}{d {Q}_{a}} ) - V ( \frac{d {Q}_{a}}{d {Q}_{a}} ) )}{{Q}_{a}^{2}} \qquad Equation 5$$

L is a constant, and therefore drops out,

dQₐ/dQₐ=1

and

dV/dQₐ=2mᵥmₕQₐ+mᵥcₕ+mₕcᵥ.

Therefore, Equation 5 can therefore be written as:

$$\frac{d α}{d {Q}_{a}} = {m}_{v} {m}_{h} - \frac{{c}_{v} {c}_{h}}{{Q}_{a }^{2}} \qquad Equation 6$$

At the gas flow rate providing peak recovery, dα/dQₐ=0, so:

$${Q}_{a , PEAK} = {( \frac{{c}_{v} {c}_{h}}{{m}_{v} {m}_{h}} )}^{1 / 2} \qquad Equation 7$$

Equation 7 shows that the peak gas recovery rate can be determined by knowing the gradient and intercept of the linear fit of both froth velocity and overflowing froth height as they change with increasing gas rate.

Returning to the examples shown in FIG. 5 and FIG. 6, Equation 7 can be tested to determine whether the positions of peak gas recovery shown in FIG. 4 are correctly predicted. This data is presented in Table 1. It can be seen that the values calculated using Equation 7 match closely with those determined from the experimental values of air recovery, showing the potential of this new methodology.

TABLE 1
Verification of modelled and experimentally
determined peak gas recovery flow rates

| Froth | | | | | Calculated | Experimental |
|---|---|---|---|---|---|---|
| Depth | mᵥ | cᵥ | mₕ | cₕ | Q_{a, PEAK} | Q_{a, PEAK} |
| 50% | 1.22 | −30.3 | −1.75 | 74.1 | 32.4 | 32 |
| 65% | 1.38 | −33.1 | −1.64 | 66.5 | 31.2 | 32 |
| 75% | 0.94 | −20.2 | −2.04 | 79.1 | 28.9 | 28 |

It is also apparent from Equation 7 that the flow rate at peak gas recovery can be calculated without knowledge of the actual gas rate into the cells. It is only necessary to know the coefficients for the linear correlations. That is, even arbitrary assignments or values to gas rates would be sufficient to enable the derivation of the values in Equation 7. In practice, this means that, as long as there is a proportional relationship between the actual gas flow rate and the apparent or nominal gas flow rate into a froth flotation cell, a value of the nominal or apparent gas flow rate can be found using Equation 7 at which peak gas recovery is achieved. That is determining a correlation between the measured values of froth velocity and the gas flow rate into the cell and determining a correlation between the measured values of froth height and the gas flow rate into the cell enables the calculation of the optimum gas flow rate. There is no need to quantify the more complicated relationship between gas recovery and input gas flow rate.

This surprising result means that it is unnecessary to involve complicated procedures to measure the true gas flow rate into froth flotation cells in order to discover the peak gas recovery. Further, it is unnecessary to perform extensive experimental calibrations in order to determine the flow rate that achieves peak gas recovery. Indeed, the above mathematical derivation only relies on the ability to interpolate a straight line for measured data, and thus (as a minimum) only requires two measurement points, neither of which needs to be at the peak gas recovery flow rate.

This also enables ease of implementation, because the optimal gas flow rate setting can be derived in the same nominal or apparent scale as used when taking the original measurements. That is, the optimum set value can be determined and set relative to the gas flow rate values used for taking the initial measurements.

In fact, the present method means that it is possible to calculate the gas flow rate giving peak gas recovery without needing to take experimental measurements at gas flow rates above and below the flow rate giving peak gas recovery. Previously this was always necessary to identify the location of the peak in the graph of input gas flow rate versus gas recovery.

In practice, it may be desirable to take more measurements than just two, to ensure more accurate linear interpolation. Further, taking more measurements will help confirm that the cell is operating in the linear regime (i.e. that froth velocity increase with increasing gas rate is linear, and that the overflowing froth height decreases with increasing air ration in a linear fashion).

The method also allows for the treatment of the measured values of the froth height and froth velocity independently of each other provides a further simplification to determining the optimum gas flow rate. Past methods of determining the gas flow rate giving peak gas recovery required the calculation of the air recovery, which in turn required measurements such as froth height and froth velocity to be taken at each point (i.e. gas flow rate) of interest and for measurements to be taken either side of the optimal gas flow rate. According to the present method measurements of froth height and froth velocity may be taken for different values of input gas flow rate and the subsequent data can be analysed independently.

The method according to the embodiments of the present invention thus enables individual cells in a bank to be individually calibrated and/or controlled in order to optimise gas recovery and hence achieve optimum performance from that cell.

The above discussed mathematical derivation can be used to implement control of a froth flotation cell. For example, by performing a calibration method in which the overflow froth velocity and the froth height are measured at two different gas flow rates, the flow rate achieving peak gas recovery can be calculated and the air flow rate into a froth flotation cell can be controlled to be that value.

Advantageously, when operating in a bank of cells, each individual cell can be optimised separately. This is because the air input to each cell is provided individually. This would allow for each individual cell to be continuously monitored and optimised, irrespective of the upstream operations, for example.

Methods of operating a froth flotation cell are now described with reference to FIG. 7.

FIG. 7 shows a flow chart for operating a froth flotation cell and controlling the gas recovery in the froth.

At step S701, a liquid is supplied to a froth flotation cell. This liquid contains the substances to be separated, which may (for example) be particles of an ore that has previously been subjected to a comminution process. The liquid may also contain various additives in order to aid the separation.

At step S702, the liquid in the froth flotation cell is supplied with a gas. The gas is preferably supplied into the cell in the form of small bubbles, or the cell may contain shearing means to break up the incoming gas stream into bubbles. The gas may be a mixture of gases, such as air. As the gas rises through the liquid, hydrophobic particles attach to the bubble interface, and a froth is formed as the bubbles reach the surface of the liquid. The froth formed above the surface of the liquid extends to an overflow point in the cell, or weir for collecting the froth, via which the froth leaves the cell. That is, a froth depth is defined between the overflow point and the surface of the liquid. In practice, the froth will also contain some entrained liquid, and so contain both hydrophobic and hydrophilic particles.

At step S703, the input gas flow rate is varied and volumes of froth overflow velocity and froth height are measured at different input gas flow rates. The measurements are taken for at least two flow rates. This step (and subsequent steps S704 and S705) may be performed by an automatic controller.

As mentioned above, various processes for measuring the froth velocity and froth height may be used. One option is to take images of the froth (e.g. using spectral analysis) that could be used to determine dynamic changes.

At step S704, the measured values of froth velocity and froth height are used to calculate the flow rate that provides peak gas recovery, using the analysis as described above.

In step S705 the input gas flow rate is adjusted to the calculated flow rate to provide peak gas recovery. The method then ends at step S706.

After the input flow rate has been set, it may be desirable to repeat the method after a certain period of time. This will allow the apparatus to account for any changes in the gas input characteristics. It may also be desirable to periodically check automatically that the flow rate has not been changed from the set point.

It will be appreciated that in a preferred embodiment the operation of each flotation cell in a bank, plant or other circuit of cells will be optimised using gas recovery maximisation, however it is possible to maximise gas recovery for any number of cells within a circuit in order to improve cumulative grade and recovery of the concentrate extracted therefrom.

By using gas recovery as the control parameter, the method enables an increased amount of desired solids to be extracted from particles or other matter that is fed into a flotation cell, whilst at the same time limiting the amount of undesired solids extracted from the cell. By using this approach of minimising the amount of undesired material extracted, the method achieves enhanced performance with respect to both grade and recovery of desired solid, as compared to known processes which concentrate on achieving high proportions of desired material and as a result only optimise at best one or other of grade and recovery.

The method according to embodiments of the present invention is straightforward to carry out as it only uses measurements that can be obtained, for example, from image analysis of a flotation cell in operation. No complicated measurements to establish actual gas flow rates are required in order to calibrate the flotation cells. As a result, the method can be used for troubleshooting and as an optimisation tool for flotation performance improvement. Furthermore, gas recovery tests as described can be used as a quick and reliable method for designing an experimental program.

A control program can be designed in order to control the operation of a plant or bank of froth flotation cells according to the method described above. In particular, a computer-implementable program can be designed for controlling operation of a plant or bank of froth flotation cells, wherein the gas flow rate into each individual cell is optimised based on the calculation of the flow rate achieving PAR as previously discussed. It is also possible to record instructions for performing this program on a computer readable medium, for execution at the plant or bank.

The above described methods have been directed mainly to extracting mineral from ore however it will be appreciated that the control and calibration methods can be used in any froth flotation process. Examples include de-inking of paper, wherein it is the undesired ink that is removed via the froth, and the desired paper that remains in the pulp in the flotation cell. The present method can also be used for calibration and control of froth flotation cells for protein separation, molecular separation and waste separation.

1. A method of controlling operation of a froth flotation cell, the method comprising:
introducing gas into a liquid in the cell, thereby to create a froth on the surface of the liquid, which froth overflows and leaves the cell at an overflow point, wherein the froth has a froth height from the level of the overflow point to the upper surface of the froth,
measuring values of the froth height for two values of gas flow rate into the cell,
measuring values of the velocity at which the froth overflows at the overflow point for two values of gas flow rate into the cell,
calculating a gas flow rate into the cell that optimises gas recovery, by treating the measured values of froth height and measured values of froth velocity independently, and
setting the gas flow rate into the cell to be the calculated flow rate into the cell that optimises gas recovery.

2. The method according to claim 1, wherein using the measured values to calculate a gas flow rate into the cell that optimises gas recovery further comprises:
determining a correlation between the measured values of froth velocity and the gas flow rate into the cell, and
determining a correlation between the measured values of froth height and the gas flow rate into the cell.

3. The method according to claim 2, wherein the correlations are linear correlations of the form y=mx+c, wherein y is the measured value of the froth velocity or froth height, x is the gas flow rate into the cell and m and c are derived coefficients.

4. The method according to claim 3, wherein using the measured values to calculate a gas flow rate into the cell that optimises gas recovery further comprises:
calculating the gas flow rate into the cell that optimises gas recovery using the coefficients m and c of the linear correlations.

5. The method according to claim 4, wherein the gas flow rate into the cell that optimises gas recovery is calculated using the following equation:
$${Q}_{a} = {( \frac{{c}_{v} {c}_{h}}{{m}_{v} {m}_{h}} )}^{1 / 2}$$
wherein Qₐ is the gas flow rate into the cell that optimises gas recovery, mᵥ and cᵥ are the coefficients of the liner correlation between the gas flow rate into the cell and the froth velocity, and mₕ and cₕ are the coefficients of the liner correlation between the gas flow rate into the cell and the froth height.

6. The method according to claim 1, wherein the gas flow rate into the cell is an apparent gas flow rate.

7. The method according to claim 1 wherein the step of setting the gas flow rate into the cell comprises setting the gas flow rate relative to the values of the gas flow rate used in the steps of measuring.

8. The method according to claim 1, further comprising using a detector to measure the velocity at which froth overflows from the cell.

9. The method according to claim 7, wherein the detector comprises a camera and image analysis system.

10. The method according to claim 1, wherein measuring the froth height comprises using a laser measure to measure the froth height.

11. The method according to claim 1, wherein the liquid contains both desired matter to be recovered and undesired matter to be discarded, wherein the cell is operable to perform at least partial separation of the desired matter and undesired matter.

12. The method according claim 1, wherein the liquid includes froth overflow from a froth flotation cell.

13. The method according to claim 1, wherein the liquid contains particles of an ore, and the ore contains minerals to be separated from the remainder of the ore.

14. A method of controlling operation of a bank of froth flotation cells including individually controlling cells according to the method of claim 1.

15. A method of controlling operation of a plant comprising a plurality of froth flotation cell banks including individually controlling banks according to the method of claim 13.

16. A method of operating a froth flotation cell including controlling operation of the cell according to the method of claim 1.

17. A method of operating a bank or plant comprising a plurality of froth flotation cells including controlling operation of the cells individually according to the method of claim 13.

18. A method of obtaining a substance from a liquid containing two or more substances including adding said liquid to a froth flotation cell, operating the cell according to the method of claim 15, and obtaining the substance from the froth which overflows the cell during operation.

19. A method of obtaining a substance from a liquid containing two or more substances including adding said liquid to a froth flotation bank or plant, operating the bank or plant according to the method of claim 16, and obtaining the substance from the matter which remains in the bank or plant after operation.

20. A method of obtaining a refined ore, the method comprising a method according to claim 18.

21. A substance recovered from froth which overflows from a froth flotation cell, or liquid retained in the cell, wherein said froth flotation cell is controlled according to the method of claim 1.

22. A computer readable medium containing instructions for controlling a froth flotation cell according to the method of claim 1.

23. A froth flotation cell comprising:
a gas inlet for introducing gas into a liquid in the cell and,
a controller configured to calculate a gas flow rate into the cell that optimises gas recovery based upon measured values of froth height for two values of gas flow rate into the cell and measured values of froth velocity for two values of gas flow rate into the cell, the calculation being performed by treating the measured values of froth height and the measured values of froth velocity independently, the controller being further configured and to control the gas inlet to set the gas flow rate into the cell to be the calculated flow rate into the cell that optimises gas recovery.

24. A froth flotation plant including a plurality of froth flotation cells as claimed in claim 22.

25. A control system for controlling a flotation cell, the control system comprising:
a measuring unit for measuring values of froth height and froth velocity,
a calculating unit for calculating a gas flow rate into the cell that optimises gas recovery based upon values measured by the measuring unit, the calculation being performed by treating the measured values of froth height and the measured values of froth velocity independently, and
a controller to set the gas flow rate into the cell to be the calculated flow rate into the cell that optimises gas recovery.

26. (canceled)

27. (canceled)

28. (canceled)
